(19) United States
(12) Patent Application Publication
(10) Pub. No.: US 2025/0071849 A1
(43) Pub. Date: Feb. 27, 2025

(54) METHODS AND APPARATUSES FOR HANDLING A RELAY LINK WITH TRACKING AREA UPDATE (TAU) AND RADIO ACCESS NETWORK BASED NOTIFICATION AREA UPDATE (RNAU) IN L2 U2N RELAY CASE

(71) Applicant: LENOVO (BEIJING) LIMITED, Beijing (CN)

(72) Inventors: Lianhai WU, Beijing (CN); Ran YUE, Beijing (CN); Jing HAN, Beijing (CN); Haiming WANG, Beijing (CN); Min XU, Beijing (CN)

(21) Appl. No.: 18/723,626

(22) PCT Filed: Feb. 10, 2022
(86) PCT No.: PCT/CN2022/075816

§ 371 Date: Jun. 24, 2024

(51) Int. Cl. H04W 76/27; H04W 24/08; H04W 40/22

(52) U.S. Cl. CPC H04W 76/27; H04W 24/08; H04W 40/22

(57) ABSTRACT

Embodiments of the present application relate to methods and apparatuses of handling a relay link with tracking area update (TAU) and radio access network based notification area update (RNAU) in a layer-2 (L2) UE-to-Network (U2N) relay case. According to an embodiment of the present application, a user equipment (UE) includes a processor and a transceiver coupled to the processor; and the processor is configured: to access a serving cell via a relay UE; and to receive a radio resource control (RRC) message via the transceiver from the serving cell, wherein the RRC message includes at least one of: a RRC reconfiguration message; or a RRC release message.

### TECHNICAL FIELD

Embodiments of the present application generally relate to wireless communication technology, in particular to methods and apparatuses of handling a relay link with tracking area update (TAU) and radio access network based notification area update (RNAU) in a layer-2 (L2) UE-to-Network (U2N) relay case.

### BACKGROUND

Vehicle to everything (V2X) has been introduced into 5G wireless communication technology. In terms of a channel structure of V2X communication, the direct link between two user equipments (UEs) is called a sidelink. A sidelink is a long-term evolution (LTE) feature introduced in 3GPP Release 12, and enables a direct communication between proximal UEs, and data does not need to go through a base station (BS) or a core network.

In the 3rd Generation Partnership Project (3GPP), deployment of a relay node (RN) in a wireless communication system is promoted. One objective of deploying a RN is to enhance the coverage area of a BS by improving the throughput of a user equipment (UE) that is located in the coverage or far from the BS, which can result in relatively low signal quality. A RN may also be named as a relay UE in some cases. A 3GPP 5G sidelink system including a relay UE may be named as a sidelink relay system. A U2N relay UE is a UE that provides functionality to support connectivity to the network for U2N remote UE(s).

Currently, in a wireless communication system or the like, details regarding handling a relay link with TAU and RNAU in a L2 U2N relay case have not been specifically discussed yet.

### SUMMARY

Some embodiments of the present application provide a user equipment (UE). The UE includes a processor and a transceiver coupled to the processor; and the processor is configured: to access a serving cell via a relay UE; and to receive a radio resource control (RRC) message via the transceiver from the serving cell, wherein the RRC message includes at least one of: a RRC reconfiguration message; or a RRC release message.

In some embodiments, in response to the RRC message including the RRC reconfiguration message, the RRC reconfiguration message includes a measurement configuration, and the measurement configuration includes at least one of: a blacklist of cells, wherein each cell within the blacklist of cells is not applicable for an event evaluation or a measurement procedure; or a whitelist of cells, wherein each cell within the whitelist of cells is applicable for the event evaluation or the measurement procedure.

In some embodiments, in response to the serving cell of the relay UE belonging to the blacklist, the relay UE is not applicable for the event evaluation or the measurement procedure. In some embodiments, in response to the serving cell of the relay UE belonging to the whitelist, the relay UE is applicable for the event evaluation or the measurement procedure. In some embodiments, in response to the serving cell of the relay UE belonging to neither the blacklist nor the whitelist: the relay UE is not applicable for the event evaluation or the measurement procedure; or the relay UE is applicable for the event evaluation or the measurement procedure.

In some embodiments, the processor of the UE is configured to report a measurement result once an event associated with the relay UE is fulfilled during performing the event evaluation, in response to the relay UE being applicable for the event evaluation or the measurement procedure.

In some embodiments, the event associated with the relay UE includes one of: the relay UE becomes worse than a first threshold, and a second cell becomes better than a second threshold; the relay UE becomes worse than a third threshold; the relay UE becomes worse than a fourth threshold, and a candidate relay UE becomes better than a fifth threshold; or the candidate relay UE becomes better than a sixth threshold.

In some embodiments, the processor of the UE is configured: to enter a RRC idle state, in response to the RRC message including the RRC release message; to initiate a RRC setup request procedure; and to start a timer associated with RRC setup request upon transmitting a RRC setup request message.

In some embodiments, the processor of the UE is configured to perform a unified access control procedure in response to initiating the RRC setup request procedure.

In some embodiments, the processor of the UE is configured to start a timer associated with access barring check, in response to an access attempt of the UE being considered as barred.

In some embodiments, the processor of the UE is configured to stop the timer associated with access barring check, in response to the timer associated with access barring check being running and in response to fulfilling at least one of: a relay selection or relay reselection; a change of the serving cell due to the relay selection or relay reselection; a relay reselection and a second serving cell of a selected relay UE being different from the serving cell of the UE; or receiving, from the relay UE, a notification message associated with at least one indication of: the relay UE handover, a radio link failure (RLF) on a Uu link of the relay UE, or a cell reselection of the relay UE.

In some embodiments, in response to receiving a notification message including an indication of cell reselection from the relay UE and in response to a reselected cell and the serving cell belonging to different tracking areas, the processor of the UE is configured: to stop the timer associated with RRC setup request in response to the timer associated with RRC setup request being running, and to perform a tracking area update (TAU) procedure; or to perform a RRC setup procedure.

In some embodiments, the processor of the UE is configured: to initiate a RRC reestablishment procedure, in response to: declaring a radio link failure (RLF); or receiving a notification message associated with at least one indication of the relay UE handover or a RLF on a Uu link of the relay UE; to transmit a RRC reestablishment request message; and to start a timer associated with RRC reestablishment request.

In some embodiments, in response to receiving a notification message including an indication of cell reselection from the relay UE, and in response to a reselected cell and the serving cell belonging to different tracking areas: the processor of the UE is configured: to stop the timer associated with RRC reestablishment request in response to the timer associated with RRC reestablishment request being running, and to perform a tracking area update (TAU) procedure; or to perform a RRC reestablishment procedure.

In some embodiments, wherein the processor of the UE is configured: to enter a RRC inactive state, in response to the RRC message including the RRC release message and in response to the RRC release message including a suspend indication; to transmit a RRC resume request message; and to start a timer associated with RRC resume request.

In some embodiments, in response to receiving a notification message including an indication of cell reselection from the relay UE, and in response to a reselected cell and the serving cell belonging to different radio access network based notification areas (RNAs), the processor of the UE is configured: to stop the timer associated with RRC resume request in response to the timer associated with RRC resume request being running, and to perform a radio access network based notification area update (RNAU) procedure; or to perform a RRC resume procedure.

In some embodiments, the notification message received from the relay UE includes identity (ID) information of the reselected cell. In some embodiments, the ID information of the reselected cell includes at least one of: a new radio cell identity (NCI) of the reselected cell; a cell ID of the reselected cell; or a public land mobile network (PLMN) ID of the reselected cell.

In some embodiments, the RRC resume request message includes a resume cause. In response to performing the RNAU procedure, the resume cause is associated with the RNAU procedure. In response to performing the RRC resume procedure, the resume cause is associated with data or signalling transmission.

Some embodiments of the present application provide a network node (e.g., a BS). The network node includes a processor and a transceiver coupled to the processor; and the processor is configured: to transmit, via the transceiver, a measurement configuration to a remote user equipment (UE) via a relay UE, wherein the remote UE communicates with a serving cell of the network node via the relay UE, and wherein the measurement configuration includes at least one of: a blacklist of cells, wherein each cell within the blacklist of cells is not applicable for an event evaluation or a measurement procedure; or a whitelist of cells, wherein each cell within the whitelist of cells is applicable for the event evaluation or the measurement procedure.

In some embodiments, in response to the relay UE belonging to the blacklist, the relay UE is not applicable for the event evaluation or the measurement procedure. In some embodiments, in response to the relay UE belonging to the whitelist, the relay UE is applicable for the event evaluation or the measurement procedure. In some embodiments, in response to the relay UE belonging to neither the blacklist nor the whitelist: the relay UE is not applicable for the event evaluation or the measurement procedure; or the relay UE is applicable for the event evaluation or the measurement procedure.

In some embodiments, the processor of the network node is configured to receive a measurement result once an event associated with the relay UE is fulfilled during performing the event evaluation, in response to the relay UE being applicable for the event evaluation or the measurement procedure.

In some embodiments, the event associated with the relay UE includes one of: the relay UE becomes worse than a first threshold, and a second cell becomes better than a second threshold; the relay UE becomes worse than a third threshold; the relay UE becomes worse than a fourth threshold, and a candidate relay UE becomes better than a fifth threshold; or the candidate relay UE becomes better than a sixth threshold.

Some embodiments of the present application provide a relay UE. The relay UE includes a processor and a transceiver coupled to the processor; and the processor is configured: to access a first serving cell, wherein a remote UE communicates with the first serving cell via the relay UE; to perform a handover procedure or declaring a radio link failure (RLF) on a Uu link of the relay UE; and to transmit a notification message associated with at least one indication of: the handover procedure, or the RLF on the Uu link of the relay UE.

In some embodiments, the processor of the relay UE is configured to transmit a discovery message including identity (ID) information of a second serving cell, in response to at least one of: successfully completing the handover procedure; or successfully completing a radio resource control (RRC) reestablishment procedure.

In some embodiments, the ID information of the second serving cell includes at least one of: a new radio cell identity (NCI) of the second serving cell; a cell ID of the second serving cell; or a public land mobile network (PLMN) ID of the second serving cell.

Some embodiments of the present application provide a method, which may be performed by a UE. The method includes: accessing a serving cell via a relay UE; and receiving a radio resource control (RRC) message from the serving cell, wherein the RRC message includes at least one of: a RRC reconfiguration message; or a RRC release message.

In some embodiments, in response to the RRC message including the RRC reconfiguration message, the RRC reconfiguration message includes a measurement configuration, and wherein the measurement configuration includes at least one of: a blacklist of cells, wherein each cell within the blacklist of cells is not applicable for an event evaluation or a measurement procedure; or a whitelist of cells, wherein each cell within the whitelist of cells is applicable for the event evaluation or the measurement procedure.

In some embodiments, in response to the serving cell of the relay UE belonging to the blacklist, the relay UE is not applicable for the event evaluation or the measurement procedure; or in response to the serving cell of the relay UE belonging to the whitelist, the relay UE is applicable for the event evaluation or the measurement procedure.

In some embodiments, in response to the serving cell of the relay UE belonging to neither the blacklist nor the whitelist: the relay UE is not applicable for the event evaluation or the measurement procedure; or the relay UE is applicable for the event evaluation or the measurement procedure.

In some embodiments, the method further comprises reporting a measurement result once an event associated with the relay UE is fulfilled during performing the event evaluation, in response to the relay UE being applicable for the event evaluation or the measurement procedure.

In some embodiments, the event associated with the relay UE includes one of: the relay UE becomes worse than a first threshold, and a second cell becomes better than a second threshold; the relay UE becomes worse than a third threshold; the relay UE becomes worse than a fourth threshold, and a candidate relay UE becomes better than a fifth threshold; or the candidate relay UE becomes better than a sixth threshold.

In some embodiments, the method further comprises: in response to the RRC message including the RRC release message, entering a RRC idle state; initiating a RRC setup request procedure; and starting a timer associated with RRC setup request upon transmitting a RRC setup request message.

In some embodiments, the method further comprises performing a unified access control procedure, in response to initiating the RRC setup request procedure.

In some embodiments, the method further comprises starting a timer associated with access barring check, in response to an access attempt of the UE being considered as barred.

In some embodiments, the method further comprises stopping the timer associated with access barring check, in response to the timer associated with access barring check being running and in response to fulfilling at least one of: a relay selection or relay reselection; a change of the serving cell due to the relay selection or relay reselection; a relay reselection and a second serving cell of a selected relay UE being different from the serving cell of the UE; or receiving, from the relay UE, a notification message associated with at least one indication of: the relay UE handover, a radio link failure (RLF) on a Uu link of the relay UE, or a cell reselection of the relay UE.

In some embodiments, in response to receiving a notification message including an indication of cell reselection from the relay UE, and in response to a reselected cell and the serving cell belonging to different tracking areas, the method further comprises: stopping the timer associated with RRC setup request in response to the timer associated with RRC setup request being running, and performing a tracking area update (TAU) procedure; or performing a RRC setup procedure.

In some embodiments, the method further comprises: initiating a RRC reestablishment procedure, in response to: declaring a radio link failure (RLF); or receiving a notification message associated with at least one indication of: the relay UE handover, or a RLF on a Uu link of the relay UE; transmitting a RRC reestablishment request message; and starting a timer associated with RRC reestablishment request.

In some embodiments, in response to receiving a notification message including an indication of cell reselection from the relay UE, and in response to a reselected cell and the serving cell belonging to different tracking areas, the method further comprises: stopping the timer associated with RRC reestablishment request in response to the timer associated with RRC reestablishment request being running, and performing a tracking area update (TAU) procedure; or performing a RRC reestablishment procedure.

In some embodiments, the method further comprises: in response to the RRC message including the RRC release message and in response to the RRC release message including a suspend indication, entering a RRC inactive state; transmitting a RRC resume request message; and starting a timer associated with RRC resume request.

In some embodiments, in response to receiving a notification message including an indication of cell reselection from the relay UE, and in response to a reselected cell and the serving cell belonging to different radio access network based notification areas (RNAs), the method further comprises: stopping the timer associated with RRC resume request in response to the timer associated with RRC resume request being running, and performing a radio access network based notification area update (RNAU) procedure; or performing a RRC resume procedure.

In some embodiments, the notification message received from the relay UE includes identity (ID) information of the reselected cell. In some embodiments, the ID information of the reselected cell includes at least one of: a new radio cell identity (NCI) of the reselected cell; a cell ID of the reselected cell; or a public land mobile network (PLMN) ID of the reselected cell.

In some embodiments, the RRC resume request message includes a resume cause, and wherein: in response to performing the RNAU procedure, the resume cause is associated with the RNAU procedure; or in response to performing the RRC resume procedure, the resume cause is associated with data or signalling transmission.

Some embodiments of the present application provide a method, which may be performed by a network node (e.g., a BS). The method includes: transmitting a measurement configuration to a remote user equipment (UE) via a relay UE, wherein the remote UE communicates with a serving cell of the network node via the relay UE, and wherein the measurement configuration includes at least one of: a blacklist of cells, wherein each cell within the blacklist of cells is not applicable for an event evaluation or a measurement procedure; or a whitelist of cells, wherein each cell within the whitelist of cells is applicable for the event evaluation or the measurement procedure.

In some embodiments, in response to the relay UE belonging to the blacklist, the relay UE is not applicable for the event evaluation or the measurement procedure. In some embodiments, in response to the relay UE belonging to the whitelist, the relay UE is applicable for the event evaluation or the measurement procedure. In some embodiments, in response to the relay UE belonging to neither the blacklist nor the whitelist: the relay UE is not applicable for the event evaluation or the measurement procedure; or the relay UE is applicable for the event evaluation or the measurement procedure.

In some embodiments, the method further comprises receiving a measurement result once an event associated with the relay UE is fulfilled during performing the event evaluation, in response to the relay UE being applicable for the event evaluation or the measurement procedure.

In some embodiments, the event associated with the relay UE includes one of: the relay UE becomes worse than a first threshold, and a second cell becomes better than a second threshold; the relay UE becomes worse than a third threshold; the relay UE becomes worse than a fourth threshold, and a candidate relay UE becomes better than a fifth threshold; or the candidate relay UE becomes better than a sixth threshold.

Some embodiments of the present application provide a method, which may be performed by a relay UE. The method includes: accessing a first serving cell, wherein a remote UE communicates with the first serving cell via the relay UE; performing a handover procedure or declaring a radio link failure (RLF) on a Uu link of the relay UE; and transmitting a notification message associated with at least one indication of: the handover procedure, or the RLF on the Uu link of the relay UE.

In some embodiments, the method further comprises transmitting a discovery message including identity (ID) information of a second serving cell, in response to at least one of: successfully completing the handover procedure; or successfully completing a radio resource control (RRC) reestablishment procedure.

In some embodiments, the ID information of the second serving cell includes at least one of: a new radio cell identity (NCI) of the second serving cell; a cell ID of the second serving cell; or a public land mobile network (PLMN) ID of the second serving cell.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a UE, a relay UE, or a network node (e.g., a BS).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates an exemplary flowchart of a sidelink RRC reconfiguration procedure in accordance with some embodiments of the present application.

FIG. 3 illustrates a flow chart of an exemplary procedure of wireless communications in accordance with some embodiments of the present disclosure.

FIG. 4 illustrates a flow chart of an exemplary procedure of wireless communications in accordance with some embodiments of the present disclosure.

FIG. 5 illustrates a flow chart of an exemplary procedure of wireless communications in accordance with some embodiments of the present disclosure.

FIG. 6 illustrates an exemplary block diagram of an apparatus for a L2 U2N relay case according to some embodiments of the present application.

FIG. 7 illustrates a further exemplary block diagram of an apparatus for a L2 U2N relay case according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd Generation Partnership Project (3GPP) LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

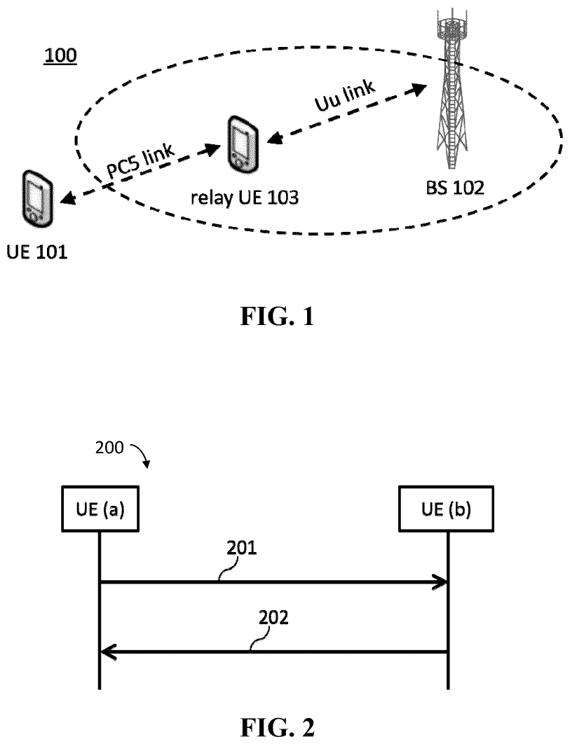

FIG. 1 illustrates a schematic diagram of a wireless communication system 100 in accordance with some embodiments of the present application. As shown in FIG. 1, the wireless communication system 100 includes UE 101, BS 102, and relay UE 103 for illustrative purpose. Although a specific number of UE(s), relay UE(s), and BS(s) are depicted in FIG. 1, it is contemplated that any number of UE(s), relay UE(s), and BS(s) may be included in the wireless communication system 100.

Due to a far distance between UE 101 and BS 102, these they communicate with each other via relay UE 103. UE 101 may be connected to relay UE 103 via a network interface, for example, a PC5 interface as specified in 3GPP standard documents. Relay UE 103 may be connected to BS 102 via a network interface, for example, a Uu interface as specified in 3GPP standard documents. Referring to FIG. 1, UE 101 is connected to relay UE 103 via a PC5 link, and relay UE 103 is connected to BS 102 via a Uu link. UE 101 may be a U2N remote UE. Relay UE 103 may be a U2N relay UE, which is a UE that provides functionality to support connectivity to the network for U2N remote UE(s).

In some embodiments of the present application, UE 101 or relay UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

In some further embodiments of the present application, UE 101 or relay UE 103 may include a portable wireless communication device, a smart phone, a cellular telephone, a flip phone, a device having a subscriber identity module, a personal computer, a selective call receiving circuitry, or any other device that is capable of sending and receiving communication signals on a wireless network.

In some other embodiments of the present application, UE 101 or relay UE 103 may include wearable devices, such as smart watches, fitness bands, optical head-mounted displays, or the like. Moreover, UE 101 or relay UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

BS(s) 102 may be distributed over a geographic region. In certain embodiments of the present application, each of the BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) 102 transmit data using an OFDM modulation scheme on the downlink (DL), and UE(s) 101 (e.g., UE 101 or other similar UE) transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 702.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of present application, BS(s) 102 may communicate with UE(s) 101 using the 3GPP 5G protocols.

UE(s) 101 may access BS(s) 102 to receive data packets from BS(s) 102 via a downlink channel and/or transmit data packets to BS(s) 102 via an uplink channel. In normal operation, since UE(s) 101 does not know when BS(s) 102 will transmit data packets to it, UE(s) 101 has to be awake all the time to monitor the downlink channel (e.g., a Physical Downlink Control Channel (PDCCH)) to get ready for receiving data packets from BS(s) 102. However, if UE(s) 101 keeps monitoring the downlink channel all the time even when there is no traffic between BS(s) 102 and UE(s) 101, it would result in significant power waste, which is problematic to a power limited UE or a power sensitive UE.

FIG. 2 illustrates an exemplary flowchart of a sidelink RRC reconfiguration procedure in accordance with some embodiments of the present application. As shown in FIG. 2, in step 201, UE (a) (e.g., UE 101 as illustrated and shown in FIG. 1) initiates a sidelink RRC reconfiguration procedure to UE (b) (e.g., relay UE 102 as illustrated and shown in FIG. 1) by transmitting RRCReconfigurationSidelink message to UE (b).

If the sidelink RRC reconfiguration procedure is successfully completed, in step 202, UE (b) may transmit “a RRC reconfiguration complete sidelink message” to UE (a), e.g., RRCReconfigurationCompleteSidelink message as specified in 3GPP standard documents. Alternatively, if the sidelink RRC reconfiguration procedure is not successfully completed, in step 202, UE (b) may transmit “a RRC reconfiguration failure sidelink message” to UE (a), e.g., RRCReconfigurationFailureSidelink message as specified in 3GPP standard documents.

The purpose of a sidelink RRC reconfiguration procedure is to modify a PC5 RRC connection, e.g., to establish, modify, or release sidelink data radio bearers (DRBs), to configure NR sidelink measurement and reporting, and to configure sidelink channel state information (CSI) reference signal resources.

A UE (e.g., UE (a) as illustrated and shown in FIG. 2) may initiate the sidelink RRC reconfiguration procedure and perform operations on the corresponding PC5 RRC connection in following cases:
a release of sidelink DRBs associated with a peer UE (e.g., UE (b) as illustrated and shown in FIG. 2);
an establishment of sidelink DRBs associated with the peer UE;
a modification for the parameters included in Sidelink radio bearer (SLRB)-Config of sidelink DRBs associated with the peer UE;
configuration information of the peer UE to perform NR sidelink measurement and report; and
configuration information of the sidelink CSI reference signal resources.

A UE capable of NR sidelink communication may initiate a procedure of sidelink UE information for NR, to report to a network or a BS that a sidelink radio link failure (RLF) (e.g., timer T400 expiry) or a sidelink RRC reconfiguration failure has been declared.

According to 3GPP standard documents, agreements regarding core network (CN) registration for a UE in a RRC idle state (which may also be named as idle UE) are as follows. Reachability management is responsible for detecting whether the UE is reachable and providing UE location (i.e., access node) for the network to reach the UE. This is done by paging UE and UE location tracking. The UE location tracking includes both UE registration area tracking (i.e., UE registration area update) and UE reachability tracking (i.e., UE periodic registration area update). Based on the above description, there are two trigger conditions to trigger UE to perform CN registration, namely, registration area change and registration timer (Periodic Registration Update timer) expiry. CN Registration area (TrackingAreaCode IE (information element)) will be broadcasted by SIB1 (system information block 1). When idle UE leaves this registration area, idle UE needs to perform CN registration by establishing connection.

According to 3GPP standard documents, agreements regarding radio access network (RAN) based notification area are as follows. A UE in the RRC_INACTIVE state can be configured by the last serving NG-RAN node with an RNA. The RNA can cover a single or multiple cells, and shall be contained within the CN registration area; in this release Xn connectivity should be available within the RNA. A RAN-based notification area update (RNAU) is periodically sent by the UE and is also sent when the cell reselection procedure of the UE selects a cell that does not belong to the configured RNA.

ARNA update procedure involving context retrieval may be triggered when A UE moves out of the configured RNA, or periodically. During a UE triggered RNA update procedure involving context retrieval over Xn interface, the UE resumes from RRC_INACTIVE, providing the I-RNTI allocated by the last serving BS (e.g., a gNB) and appropriate cause value, e.g., RAN notification area update. The gNB, if able to resolve the gNB identity contained in the I-RNTI, requests the last serving gNB to provide UE Context, providing the received cause value. After that, the last serving gNB may provide the UE context. The gNB may send the UE back to RRC_INACTIVE. If loss of DL user data buffered in the last serving gNB shall be prevented, the gNB provides forwarding addresses. Then, the gNB performs path switch. The gNB keeps the UE in RRC_INACTIVE state by sending RRCRelease with suspend indication. After that, the gNB triggers the release of the UE resources at the last serving gNB.

According to agreements of 3GPP standard documents, four reporting events associated with a L2 U2N relay UE, i.e., Event X1, Event X2, Event Y1, and Event Y2, are introduced as below.
(1) Event X1 (Serving L2 U2N Relay UE becomes worse than threshold1 and NR Cell becomes better than threshold2)
   1>The UE shall consider the entering condition for this event to be satisfied when both condition X1-1 and condition X1-2, as specified below, are fulfilled;
   1>The UE shall consider the leaving condition for this event to be satisfied when condition X1-3 or condition X1-4, i.e., at least one of the two, as specified below, is fulfilled;
      Inequality X1-1 (Entering condition 1): Mr+Hys<Thresh1
      Inequality X1-2 (Entering condition 2): Mn+Ofn+Ocn−Hys>Thresh2
      Inequality X1-3 (Leaving condition 1): Mr−Hys>Thresh1
      Inequality X1-4 (Leaving condition 2): Mn+Ofn+Ocn+Hys<Thresh2
   The variables in the formula are defined as follows:
      Mr is the measurement result of the serving L2 U2N Relay UE, not taking into account any offsets.
      Mn is the measurement result of the NR cell, not taking into account any offsets.
      Ofn is the measurement object specific offset of the frequency of the NR cell.
      Ocn is the cell specific offset of the NR cell, and set to zero if not configured for the cell.
      Hys is the hysteresis parameter for this event.
      Thresh1 is the threshold parameter for this event (i.e., x1-Threshold1-Relay as defined within reportConfigNR for this event).
      Thresh2 is the threshold parameter for this event (i.e., x1-Threshold2 as defined within reportConfigNR for this event).
      Mr is expressed in dBm.
      Mn is expressed in dBm in case of RSRP, or in dB in case of RSRQ and RS-SINR.
      Ofn, Ocn, Hys are expressed in dB.
      Thresh1 is expressed in the same unit as Mr.
      Thresh2 is expressed in the same unit as Mn.
(2) Event X2 (Serving L2 U2N Relay UE becomes worse than threshold)
   1>The UE shall consider the entering condition for this event to be satisfied when condition X2-1, as specified below, is fulfilled;
   1>The UE shall consider the leaving condition for this event to be satisfied when condition X2-2, as specified below, is fulfilled;
      Inequality X2-1 (Entering condition): Mr+Hys<Thresh
      Inequality X2-2 (Leaving condition): Mr−Hys>Thresh
   The variables in the formula are defined as follows:
      Mr is the measurement result of the serving L2 U2N Relay UE, not taking into account any offsets.
      Hys is the hysteresis parameter for this event.
      Thresh is the threshold parameter for this event (i.e., x2-Threshold-Relay as defined within reportConfigNR for this event).
      Mr is expressed in dBm.
      Hys are expressed in dB.
      Thresh is expressed in the same unit as Mr.
(3) Event Y1 (PCell becomes worse than threshold1 and candidate L2 U2N Relay UE becomes better than threshold2)
   1>The UE shall consider the entering condition for this event to be satisfied when both condition Y1-1 and condition Y1-2, as specified below, are fulfilled;
   1>The UE shall consider the leaving condition for this event to be satisfied when condition Y1-3 or condition Y1-4, i.e., at least one of the two, as specified below, is fulfilled;
      Inequality Y1-1 (Entering condition 1): Mp+Hys<Thresh1
      Inequality Y1-2 (Entering condition 2): Mr−Hys>Thresh2
      Inequality Y1-3 (Leaving condition 1): Mp−Hys>Thresh1
      Inequality Y1-4 (Leaving condition 2): Mr+Hys<Thresh2
   The variables in the formula are defined as follows:
      Mp is the measurement result of the PCell, not taking into account any offsets.
      Mr is the measurement result of the candidate L2 U2N Relay UE, not taking into account any offsets.
      Hys is the hysteresis parameter for this event (i.e., hysteresis as defined within reportConfigInterRAT for this event).
      Thresh1 is the threshold parameter for this event (i.e., y1-Threshold1 as defined within reportConfigInterRAT for this event).
      Thresh2 is the threshold parameter for this event (i.e., y1-Threshold2-Relay as defined within reportConfigInterRAT for this even).
      Mp is expressed in dBm in case of RSRP, or in dB in case of RSRQ and SINR.
      Mr is expressed in dBm or dB, depending on the measurement quantity of candidate L2 U2N Relay UE.
      Hys are expressed in dB.
      Thresh1 is expressed in the same unit as Mp.
      Thresh2 is expressed in the same unit as Mr.
(4) Event Y2 (Candidate L2 U2N Relay UE becomes better than threshold)
   1>The UE shall consider the entering condition for this event to be satisfied when condition Y2-1, as specified below, is fulfilled;
   1>The UE shall consider the leaving condition for this event to be satisfied when condition Y2-2, as specified below, is fulfilled;
      Inequality Y2-1 (Entering condition): Mr−Hys>Thresh2
      Inequality Y2-2 (Leaving condition): Mr+Hys<Thresh2
   The variables in the formula are defined as follows:
      Mr is the measurement result of the candidate L2 U2N Relay UE, not taking into account any offsets.
      Hys is the hysteresis parameter for this event (i.e., hysteresis as defined within reportConfigInterRAT for this event).
      Thresh is the threshold parameter for this event (i.e., y2-Threshold-Relay as defined within reportConfigInterRAT for this event).
      Mr is expressed in dBm or dB, depending on the measurement quantity of candidate L2 U2N Relay UE.
      Hys are expressed in dB.
      Thresh is expressed in the same unit as Mr.

In accordance with 3GPP standard document TS38.331, timer T390 is defined as follows. A trigger condition for starting T390 is “When access attempt is barred at access barring check for an Access Category. The UE maintains one instance of this timer per Access Category”. A trigger condition for stopping T390 is “Upon cell (re)selection, upon entering RRC_CONNECTED, upon reception of RRCReconfiguration including reconfigurationWithSync, upon change of PCell while in RRC_CONNECTED, upon reception of MobilityFromNRCommand, or upon reception of RRCRelease”. At expiry of T390, a UE performs the actions as specified in section 5.3.14.4 of TS38.331.

Embodiments of the present application aim to solve issues in a L2 U2N relay case, for example, including whether blacklisted cells and whitelisted cells of remote UE can be applied to the serving cell of a relay UE, and new trigger condition(s) for stopping timer T390 in the L2 U2N relay case. For example, some embodiments of the present application study a mechanism for a case in which the serving cell of a relay UE changes after a remote UE initiates the procedure for RRCSetupRequest or RRCReestablishmentRequest, but the serving cell belongs to the different CN tracking areas. Some embodiments of the present application study a mechanism for a case in which the serving cell of a relay UE changes after a remote UE initiates the procedure for RRCResumeRequest, but the serving cell belongs to the different RAN areas. Some embodiments of the present application study a new mechanism for a remote UE to determine the time point of successful relay handover or successful recovery after receiving a notification message associated with at least one indication of: relay handover, or a Uu RLF of the relay UE. Some embodiments of the present application study new cases for cell change when timer T390 is running.

More details will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

The following texts describe specific Embodiments 1-3 of the present application, in which a remote UE, a relay UE, and a network node (e.g., a BS) perform following operations. For example, in Embodiments 1-3, the remote UE, the relay UE, and the BS may function as UE 101, relay UE 103, and BS 102, shown in FIG. 1, respectively.

### Embodiment 1

Embodiment 1 refers to a scenario in which blacklisted cells and whitelisted cells of a remote UE can be applied to a serving cell of a relay UE. In particular, following steps may be performed in Embodiment 1.
(1) Step 1: A remote UE accesses a BS via a relay UE, e.g., a L2 U2N relay UE. For instance, the BS may transmit an indication to indicate whether the L2 U2N relay UE is supported or not.
(2) Step 2: The BS transmits a RRC reconfiguration message including, e.g., a measurement configuration, to the remote UE.
   In some embodiments, the measurement configuration includes a whitelist of cells (which may be named as a list of whitelisted cells or the like) and/or a blacklist of cells (which may be named as a list of blacklisted cells or the like). The cell(s) in the whitelist is the only one(s) applicable for event evaluation (e.g., Event X1, Event X2, Event Y1, and/or Event Y2 as described above) or measurement reporting. The cell(s) in the blacklist is not applicable for event evaluation (e.g., Event X1, Event X2, Event Y1, and/or Event Y2) or measurement reporting.
   In some embodiments, reporting configurations are a list of reporting configurations in which there can be one or multiple reporting configurations per measurement object. Each measurement reporting configuration may include at least one of following:
      1) Reporting criterion: the criterion that triggers the UE to send a measurement report. This can either be periodical or a single event description.
      2) Reference signal (RS) type: the RS that the UE uses for beam and cell measurement results (SS/PBCH (synchronization signal/physical broadcast channel) block or CSI-RS (channel state information reference signal)).
      3) Reporting format: the quantities per cell and per beam that the UE includes in the measurement report (e.g., reference signal received power (RSRP)) and other associated information such as the maximum number of cells and the maximum number beams per cell to report.
(3) Step 3: The remote UE receives a discover message from the relay UE. In some embodiments, the discovery message includes the serving cell of the relay UE. For instance, a new radio cell identity (NCI) is included in the discovery message as the cell ID of the serving cell of the relay UE.
(4) Step 4: The remote UE performs a measurement procedure. There may be following different cases in different embodiments:
   The relay UE served by a cell included in the blacklist of cells (i.e., a list of blacklisted cells) may not be applicable for event evaluation or measurement reporting.
   The relay UE served by a cell included in the whitelist of cells (i.e., a list of whitelisted cells) may be applicable for event evaluation or measurement reporting
   The relay UE served by a cell belonging to neither the blacklist of cells nor the whitelist of cells may be applicable for event evaluation or measurement reporting.
   The relay UE served by a cell belonging to neither the blacklist of cells nor the whitelist of cells may not be applicable for event evaluation or measurement reporting.
(5) Step 5: The remote UE will report measurement result(s) once the event (e.g., Event X1, Event X2, Event Y1, or Event Y2) is fulfilled during performing the event evaluation. There may be following different cases in different embodiments:
   The relay UE served by a cell included in the blacklist of cells may not be included in the measurement report.
   The relay UE served by a cell not included in both the blacklist of cells and the whitelist of cells may not be included in the measurement report.

### Embodiment 2

Embodiment 2 refers to a scenario in which “the time of successful relay handover or successful recovery after receiving a notification message associated with at least one indication of relay handover or a Uu RLF of a relay UE” can be known or determined. In particular, after a remote UE prefers to keep PC5 connection after receiving a notification message associated with at least one indication of relay handover or a Uu RLF of a relay UE, if the relay UE doesn't further inform the remote UE of “succeed or failure” for relay handover or recovery, the time of transmitting a RRC reestablishment message needs to be known or determined. Following steps may be performed in Embodiment 2.
(1) Step 1: A remote UE accesses a BS via a relay UE, e.g., a L2 U2N relay UE. For instance, the BS may transmit an indication to indicate whether the L2 U2N relay UE is supported or not.
(2) Step 2: The BS transmits a RRC reconfiguration message including, e.g., a measurement configuration, to the remote UE.
(3) Step 3: The remote UE receives a notification message associated with at least one indication of relay handover or a Uu RLF of the relay UE.
(4) Step 4: The remote UE decides to keep the PC5 link between the remote UE and the relay UE. In some embodiments, the remote UE does not transmit a release indication to the relay UE, if the remote UE decides to keep the PC5 link.
(5) Step 5: After the relay UE completes a handover procedure or a recovery procedure, the relay UE transmits a discovery message including a cell ID (e.g., a NCI, or a cell ID, or a public land mobile network (PLMN) ID). In some embodiments, completing the handover procedure or the recovery procedure includes, but not limited to, the successful handover, the successful recovery, the failed handover and/or the failed recovery.
(6) Step 6: The remote UE can transmit a RRC reestablishment request message based on the discovery message from the relay UE. The remote UE can deduce the successful handover or the successful recovery based on the discovery message.

### Embodiment 3

Embodiment 3 refers to a scenario which handles the case that the serving cell of a relay UE changes after a remote UE initiates the procedure for RRCResumeRequest. Embodiment 3 refers to a timer associated with associated with access barring check (e.g., T390). In particular, following steps may be performed in Embodiment 3.
(1) Step 1: A remote UE accesses a BS via a relay UE, e.g., a L2 U2N relay UE.
   In some embodiments, the remote UE receives configuration(s) including one timer associated with connection setup for indirect path, e.g., a timer associated with access barring check (e.g., T390), from the BS. For example, the configuration(s) may be received via a RRC reconfiguration message. In an embodiment, the configuration(s) can be broadcasted via SIB1 (system information block 1). For instance, the configuration(s) includes a timer value of the timer associated with access barring check (e.g., T390).
(2) Step 2: The remote UE performs an access barring check.
   In some embodiments, if the access attempt of the remote UE is considered as barred, the remote UE shall start the timer associated with access barring check (e.g., T390) for the Access Category.
(3) After Step 2, there may be following two cases in different embodiments, i.e., Case 1 and Case 2. In Case 1, Step 3 is performed. In Case 2, both Step 3′ and Step 4′ are performed.
   a) Case 1: Step 3: The remote UE stops the timer associated with access barring check (e.g., T390) when this timer is running while at least one of conditions is fulfilled.
      1) upon relay (re-)selection;
      2) upon a cell change due to the relay (re-)selection;
      3) upon relay (re-)selection and the serving cell of the selected relay is different from the current serving cell of the remote UE; or
      4) upon receiving a notification message associated with at least one indication of: a relay handover, a Uu RLF, or a cell reselection from the relay UE.
   b) Case 2:
      Step 3′: in this step, there may be following two options in different embodiments, i.e., Option 1 and Option 2:
         1) Option 1 of Step 3′: when a cell change due to relay (re-)selection occurs while the timer associated with access barring check (e.g., T390) is running, the remote UE shall stop the timer associated with access barring check (e.g., T390).
         2) Option 2 of Step 3′: when the remote UE receives “the notification message associated with at least one indication of relay handover, a Uu RLF, or cell (re-)selection” from the relay UE while the timer associated with access barring check (e.g., T390) is running, the remote UE shall stop the timer associated with access barring check (e.g., T390).
      Step 4′: If the timer associated with access barring check (e.g., T390) corresponding to the Access Category ‘2’ expires or is stopped, the remote UE considers the barring for this Access Category to be alleviated.
         1) When barring for an Access Category is considered being alleviated, if the Access Category was informed to upper layer(s) as barred, the remote UE informs upper layer(s) about barring alleviation for the Access Category.

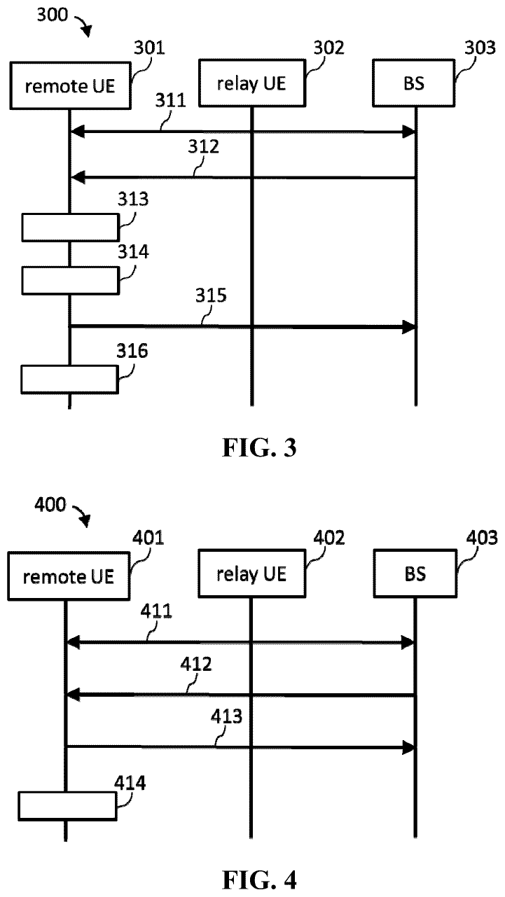

FIG. 3 illustrates a flow chart of an exemplary procedure 300 of wireless communications in accordance with some embodiments of the present disclosure. Details described in all other embodiments of the present disclosure are applicable for the embodiments shown in FIG. 3.

Exemplary procedure 300 refers to a scenario which handles the case that the serving cell of a relay UE changes after a remote UE initiates the procedure for RRC setup request. Referring to FIG. 3, remote UE 301, relay UE 302, and BS 303 may function as UE 101, relay UE 103, and BS 102, shown in FIG. 1, respectively. In particular, exemplary procedure 300 includes following steps.

In Step 311, remote UE 301 accesses BS 303 via relay UE 302, e.g., which is a L2 U2N relay UE. For example, BS 303 may transmit an indication to indicate whether the L2 U2N relay UE is supported or not.

In Step 312, BS 303 transmits a RRC release message to remote UE 301.

In Step 313, remote UE 301 enters RRC_IDLE state after remote UE 301 receives the RRC release message.

In Step 314, remote UE 301 initiates the procedure for connection establishment when upper layer(s) request establishment of an RRC connection while remote UE 301 is in RRC_IDLE state.

In Step 315, remote UE 301 transmits a RRC setup request message to BS 303 via relay UE 302, and starts timer T300 or timer “T300-remote UE” upon the transmission of the RRC setup request message.

In Step 316, there may be following two options in different embodiments, i.e., Option 1 and Option 2.
(1) In some embodiments, in Option 1 of Step 316, when remote UE 301 receives the notification message including an indication of cell (re-)selection and the (re-)selected cell of relay UE 302 belongs to the different tracking area from the current serving cell of remote UE 301, remote UE 301 stops timer T300 or timer “T300-remote UE” and performs a TAU procedure. In an embodiment, remote UE 301 receives ID information of the new serving cell included in the discovery message for the case that relay UE 302 performs a handover procedure or a RRC reestablishment procedure.
(2) In some other embodiments, in Option 2 of Step 316, when remote UE 301 receives the notification message including an indication of cell (re-)selection and the (re-)selected cell of relay UE 302 belongs to the different tracking area from the current serving cell of remote UE 301 and timer T300 or timer “T300-remote UE” is running, remote UE 301 performs a RRC setup procedure, instead of performing a TAU procedure.

It should be appreciated by persons skilled in the art that the sequence of the operations in exemplary procedure 300 in FIG. 3 may be changed and some of the operations in exemplary procedure 300 in FIG. 3 may be eliminated or modified, without departing from the spirit and scope of the disclosure.

FIG. 4 illustrates a flow chart of an exemplary procedure 400 of wireless communications in accordance with some embodiments of the present disclosure. Details described in all other embodiments of the present disclosure are applicable for the embodiments shown in FIG. 4.

Exemplary procedure 400 refers to a scenario which handles the case that the serving cell of a relay UE changes after a remote UE initiates the procedure for RRC reestablishment request. Referring to FIG. 4, remote UE 401, relay UE 402, and BS 403 may function as UE 101, relay UE 103, and BS 102, shown in FIG. 1, respectively. In particular, exemplary procedure 400 includes following steps.

In Step 411, remote UE 401 accesses BS 403 via relay UE 402, e.g., which is a L2 U2N relay UE. For example, BS 403 may transmit an indication to indicate whether the L2 U2N relay UE is supported or not.

In Step 412, BS 403 transmits a RRC reconfiguration message including, e.g., a measurement configuration, to remote UE 401.

In Step 413, remote UE 401 initiates a RRC reestablishment procedure and starts timer T301 or timer “T301-remote UE” upon the transmission of a RRC reestablishment request message.

In Step 414, there may be following two options in different embodiments, i.e., Option 1 and Option 2.
(1) In some embodiments, in Option 1 of Step 414, when remote UE 401 receives the notification message including an indication of cell (re-)selection and the (re-)selected cell of relay UE 402 belongs to the different tracking area from the current serving cell of remote UE 401 while timer T301 or timer “T301-remote UE” is running, remote UE 401 stops timer T301 or timer “T301-remote UE” and performs a TAU procedure. In an embodiment, remote UE 401 receives ID information of the new serving cell included in the discovery message for the case that relay UE 402 performs a handover procedure or a RRC reestablishment procedure.
(2) In some other embodiments, in Option 2 of Step 414, when remote UE 401 receives the notification message including an indication of cell (re-)selection and the (re-)selected cell of relay UE 402 belongs to the different tracking area from the current serving cell of remote UE 401 while timer T301 or timer “T301-remote UE” is running, remote UE 401 performs a RRC setup procedure, instead of performing a TAU procedure.

It should be appreciated by persons skilled in the art that the sequence of the operations in exemplary procedure 400 in FIG. 4 may be changed and some of the operations in exemplary procedure 400 in FIG. 4 may be eliminated or modified, without departing from the spirit and scope of the disclosure.

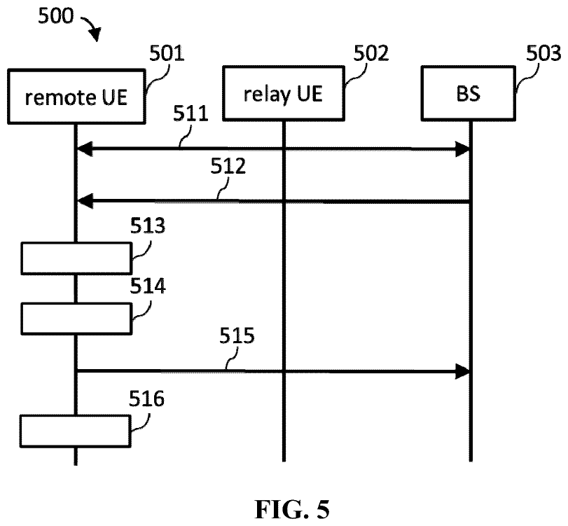

FIG. 5 illustrates a flow chart of an exemplary procedure 500 of wireless communications in accordance with some embodiments of the present disclosure. Details described in all other embodiments of the present disclosure are applicable for the embodiments shown in FIG. 5.

Exemplary procedure 500 refers to a scenario which handles the case that the serving cell of relay UE changes after the remote UE initiates the procedure for RRC resume request. Referring to FIG. 5, remote UE 501, relay UE 502, and BS 503 may function as UE 101, relay UE 103, and BS 102 shown in FIG. 1, respectively. In particular, exemplary procedure 500 includes following steps.

In Step 511, remote UE 501 accesses BS 503 via relay UE 502, e.g., which is a L2 U2N relay UE. For example, BS 503 may transmit an indication to indicate whether the L2 U2N relay UE is supported or not.

In Step 512, BS 503 transmits a RRC release message including, e.g., a suspend indication, to remote UE 501.

In Step 513, remote UE 501 enters RRC_INACTIVE state after remote UE 501 receives the RRC release message.

In Step 514, remote UE 501 initiates a RRC resume procedure.

In Step 515, remote UE 501 transmits a RRC Resume Request message and starts timer T319 or timer “T319-remote UE” upon the transmission of RRC Resume Request message.

In Step 516, there may be following two options in different embodiments, i.e., Option 1 and Option 2.
(1) In some embodiments, in Option 1 of Step 516, when remote UE 501 in the RRC_INACTIVE state receives the notification message including an indication of cell (re-)selection and the (re-)selected cell of relay UE 502 belongs to the different notification area from the current serving cell of remote UE 501 while timer T319 or timer “T319-remote UE” is running, remote UE 501 stops timer T319 or timer “T319-remote UE” and performs a RNAU procedure.
   In an embodiment in Option 1 of Step 516, the RRC resume request message includes a resume cause (e.g., ResumeCause) which is associated with the RNAU procedure. For example, ResumeCause in the RRC resume request message can set to “rna-Update”.
   In another embodiment in Option 1 of Step 516, the RRC resume request message includes a resume cause (e.g., ResumeCause) which is associated with data or signalling transmission. For example, ResumeCause in the RRC resume request message can set to be any of “mo-Signalling, mo-Data, mo-VoiceCall, mo-VideoCall, and/or mo-SMS”.
(2) In some embodiments, in Option 2 of Step 516, when remote UE 501 receives the notification message including an indication of cell (re-)selection and the (re-)selected cell of relay UE belongs to the different tracking area from the current serving cell of remote UE 501 while timer T319 or timer “T319-remote UE” is running, remote UE 501 performs a RRC resume procedure, instead of performing a RNAU procedure.
   In an embodiment in Option 2 of Step 516, the RRC resume request message includes a resume cause (e.g., ResumeCause) which is associated with data or signalling transmission. For example, ResumeCause in the RRC resume request message can set to be any of “mo-Signalling, mo-Data, mo-VoiceCall, mo-VideoCall, and/or mo-SMS”.

It should be appreciated by persons skilled in the art that the sequence of the operations in exemplary procedure 500 in FIG. 5 may be changed and some of the operations in exemplary procedure 500 in FIG. 5 may be eliminated or modified, without departing from the spirit and scope of the disclosure.

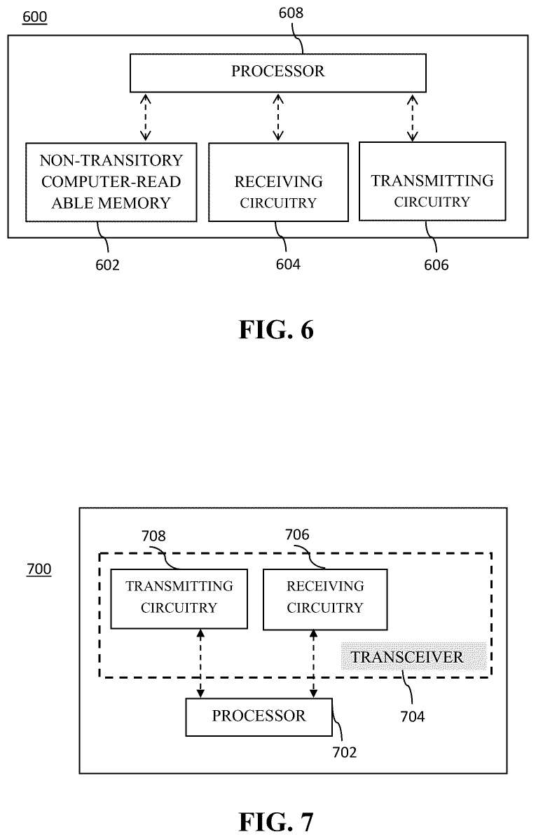

Some embodiments of the present application also provide a wireless communication apparatus for a L2 U2N relay case. For example, FIG. 6 illustrates an exemplary block diagram of an apparatus 600 for a L2 U2N relay case according to some embodiments of the present application.

As shown in FIG. 6, the apparatus 600 may include at least one non-transitory computer-readable medium 602, at least one receiving circuitry 604, at least one transmitting circuitry 606, and at least one processor 608 coupled to the non-transitory computer-readable medium 602, the receiving circuitry 604 and the transmitting circuitry 606. The at least one processor 608 may be a CPU, a DSP, a microprocessor etc. The apparatus 600 may be a network apparatus (e.g., a BS) or a UE (e.g., a remote UE or a relay UE) configured to perform a method illustrated in the above or the like.

Although in this figure, elements such as the at least one processor 608, receiving circuitry 604, and transmitting circuitry 606 are described in the singular, the plural is contemplated unless a limitation to the singular is explicitly stated. In some embodiments of the present application, the receiving circuitry 604 and the transmitting circuitry 606 can be combined into a single device, such as a transceiver. In certain embodiments of the present application, the apparatus 600 may further include an input device, a memory, and/or other components.

In some embodiments of the present application, the non-transitory computer-readable medium 602 may have stored thereon computer-executable instructions to cause a processor to implement the method with respect to a remote UE, a relay UE, or a network apparatus (e.g., a BS) as described above. For example, the computer-executable instructions, when executed, cause the processor 608 interacting with receiving circuitry 604 and transmitting circuitry 606, so as to perform the steps with respect to a remote UE, a relay UE, or a network apparatus (e.g., a BS) as illustrated above.

FIG. 7 illustrates a further exemplary block diagram of an apparatus 700 for a L2 U2N relay case according to some embodiments of the present application.

Referring to FIG. 7, the apparatus 700, for example a BS or a UE, may include at least one processor 702 and at least one transceiver 704 coupled to the at least one processor 702. The transceiver 704 may include at least one separate receiving circuitry 706 and transmitting circuitry 708, or at least one integrated receiving circuitry 706 and transmitting circuitry 708. The at least one processor 702 may be a CPU, a DSP, a microprocessor etc.

According to some other embodiments of the present application, when the apparatus 700 is a remote UE, the processor 702 may be configured: to access a serving cell via a relay UE; and to receive a RRC message via the transceiver 704 from the serving cell, wherein the RRC message includes at least one of: a RRC reconfiguration message; or a RRC release message.

According to some embodiments of the present application, when the apparatus 700 is a BS, the processor 702 is configured: to transmit, via the transceiver 704, a measurement configuration to a remote user equipment (UE) via a relay UE, wherein the remote UE communicates with a serving cell of the network node via the relay UE, and wherein the measurement configuration includes at least one of: a blacklist of cells, wherein each cell within the blacklist of cells is not applicable for an event evaluation or a measurement procedure; or a whitelist of cells, wherein each cell within the whitelist of cells is applicable for the event evaluation or the measurement procedure.

According to some embodiments of the present application, when the apparatus 700 is a relay UE, the processor 702 is configured: to access a serving cell, wherein a remote UE communicates with the serving cell via the relay UE; to perform a handover procedure or declaring a RLF on a Uu link of the relay UE; and to transmit a notification message associated with at least one indication of: the handover procedure, or the RLF on the Uu link of the relay UE.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.

1. A user equipment (UE) for wireless communication, comprising:
at least one memory; and,
at least one processor coupled with the at least one memory and configured to cause the UE to:
access a serving cell via a relay UE; and
receive a radio resource control (RRC) message from the serving cell, wherein the RRC message includes at least one of:
a RRC reconfiguration message; or
a RRC release message.

2. The UE of claim 1, wherein, when the RRC message includes the RRC reconfiguration message, the RRC reconfiguration message includes a measurement configuration, and wherein the measurement configuration includes at least one of:
a blacklist of cells, wherein each cell within the blacklist of cells is not applicable for an event evaluation or a measurement procedure; or
a whitelist of cells, wherein each cell within the whitelist of cells is applicable for the event evaluation or the measurement procedure.

3. The UE of claim 2, wherein:
when the serving cell of the relay UE belongs to the blacklist, the relay UE is not applicable for the event evaluation or the measurement procedure; or
when the serving cell of the relay UE belongs to the whitelist, the relay UE is applicable for the event evaluation or the measurement procedure.

4. The UE of claim 2, wherein, when the serving cell of the relay UE does not belong to the blacklist or the whitelist:
the relay UE is not applicable for the event evaluation or the measurement procedure; or
the relay UE is applicable for the event evaluation or the measurement procedure.

5. The UE of claim 3, wherein the at least processor is further configured to cause the UE to report a measurement result once an event associated with the relay UE is fulfilled during performance of the event evaluation and in response to the relay UE being applicable for the event evaluation or the measurement procedure.

6. The UE of claim 5, wherein the event associated with the relay UE includes one of:
the relay UE becomes worse than a first threshold, and a second cell becomes better than a second threshold;
the relay UE becomes worse than a third threshold;
the relay UE becomes worse than a fourth threshold, and a candidate relay UE becomes better than a fifth threshold; or
the candidate relay UE becomes better than a sixth threshold.

7. The UE of claim 1, wherein the at least one processor is further configured to cause the UE to:
enter an RRC idle state, in response to the RRC message including the RRC release message;
initiate an RRC setup request procedure; and
start a timer associated with an RRC setup request upon transmitting an RRC setup request message.

8. The UE of claim 7, wherein the at least one processor is further configured to cause the UE to perform a unified access control procedure in response to initiating the RRC setup request procedure.

9. The UE of claim 8, wherein the at least one processor is further configured to cause the UE to start a timer associated with an access barring check in response to an access attempt of the UE being considered as barred.

10. The UE of claim 9, wherein the at least one processor is further configured to cause the UE to stop the timer associated with the access barring check in response to the timer associated with the access barring check running and in response to fulfilling at least one of:
a relay selection or relay reselection;
a change of the serving cell due to the relay selection or relay reselection;
a relay reselection and a second serving cell of a selected relay UE being different from the serving cell of the UE; or
receiving, from the relay UE, a notification message associated with at least one indication of: the relay UE handover, a radio link failure (RLF) on a Uu link of the relay UE, or a cell reselection of the relay UE.

11. The UE of claim 7, wherein the at least one processor is further configured to cause the UE to:
in response to receiving a notification message including an indication of cell reselection from the relay UE, and in response to a reselected cell and the serving cell belonging to different tracking areas:
stop the timer associated with the RRC setup request in response to the timer associated with the RRC setup request running, and perform a tracking area update (TAU) procedure; or
perform a RRC setup procedure.

12. The UE of claim 1, wherein the at least one processor is further configured to cause the UE to:
initiate an RRC reestablishment procedure in response to: declaring a radio link failure (RLF) or receiving a notification message associated with at least one indication of: the relay UE handover, or an RLF on a Uu link of the relay UE;
transmit an RRC reestablishment request message; and
start a timer associated with RRC reestablishment request.

13. The UE of claim 12, wherein the at least one processor is further configured to cause the UE to:
in response to receiving a notification message including an indication of cell reselection from the relay UE and in response to a reselected cell and the serving cell belonging to different tracking areas:
stop the timer associated with the RRC reestablishment request in response to the timer associated with the RRC reestablishment request running, and perform a tracking area update (TAU) procedure; or
perform an RRC reestablishment procedure.

14. The UE of claim 1, wherein the at least one processor is further configured to cause the UE to:
enter an RRC inactive state in response to the RRC message including the RRC release message and in response to the RRC release message including a suspend indication;
transmit a RRC resume request message; and
start a timer associated with the RRC resume request.

15. The UE of claim 14, wherein the at least one processor is further configured to cause the UE to:
in response to receiving a notification message including an indication of cell reselection from the relay UE and in response to a reselected cell and the serving cell belonging to different radio access network based notification areas (RNAs):
stop the timer associated with the RRC resume request in response to the timer associated with the RRC resume request running, and perform a radio access network based notification area update (RNAU) procedure; or
perform an RRC resume procedure.

16. A processor for wireless communication, comprising:
at least one controller coupled with at least one memory and configured to cause the processor to:
access a serving cell via a relay UE; and
receive a radio resource control (RRC) message from the serving cell, wherein the RRC message includes at least one of:
a RRC reconfiguration message; or
a RRC release message.

17. The processor of claim 16, wherein the at least one controller is further configured to cause the processor to:
enter an RRC idle state in response to the RRC message including the RRC release message;
initiate an RRC setup request procedure; and
start a timer associated with an RRC setup request upon transmitting an RRC setup request message.

18. The processor of claim 17, wherein the at least one controller is further configured to cause the processor to perform a unified access control procedure in response to initiating the RRC setup request procedure.

19. A method performed by a user equipment (UE), the method comprising:
access a serving cell via a relay UE; and
receive a radio resource control (RRC) message from the serving cell, wherein the RRC message includes at least one of:
a RRC reconfiguration message; or
a RRC release message.

20. A relay user equipment (UE) for wireless communication, comprising:
at least one memory; and
at least one processor coupled with the at least one memory and configured to cause the UE
to:
receive a radio resource control (RRC) message from a network node; and
relay the RRC message to a user equipment (UE), wherein the RRC message includes
at least one of:
a RRC reconfiguration message; or
a RRC release message.
